(19) United States
(12) Patent Application Publication
(10) Pub. No.: US 2014/0119023 A1
(43) Pub. Date: May 1, 2014

(54) LIGHTING APPARATUS

(71) Applicants: Hyeuk CHANG, Seoul (KR); Hankyu CHO, Seoul (KR); Sangcheol LEE, Seoul (KR); Jeahyun JEONG, Seoul (KR); Bongho KIM, Seoul (KR)

(72) Inventors: Hyeuk CHANG, Seoul (KR); Hankyu CHO, Seoul (KR); Sangcheol LEE, Seoul (KR); Jeahyun JEONG, Seoul (KR); Bongho KIM, Seoul (KR)

(21) Appl. No.: 14/027,846

(22) Filed: Sep. 16, 2013

(30) Foreign Application Priority Data
Oct. 26, 2012 (KR) 10-2012-0119543
Oct. 26, 2012 (KR) 10-2012-0119544
Feb. 18, 2013 (KR) 10-2013-0016838
May 21, 2013 (KR) 10-2013-0056956

(51) Int. Cl. F21V 29/00; F21V 7/20

(52) U.S. Cl. CPC F21V 29/2206; F21V 29/2293; F21V 7/20; F21V 29/262
USPC 362/294

(57) ABSTRACT

A lighting apparatus is disclosed. The lighting apparatus is configured such that a flow route of external air passing through a heat sink and retention time of the external air are increased to improve heat dissipation efficiency, a glare phenomenon is prevented, and assemblability of the lighting apparatus is improved.

This application claims the benefit of Korean Patent Application Nos. 10-2012-0119543 filed on Oct. 26, 2012, 10-2012-0119544 filed on Oct. 26, 2012, 10-2013-0016838 filed on Feb. 18, 2013 and 10-2013-0056956 filed on May 21, 2013, which is hereby incorporated by reference as if fully set forth herein.

### BACKGROUND OF THE INVENTION

1. Field of the Invention

The present invention relates to a lighting apparatus and, more particularly, to a lighting apparatus with improved heat dissipation efficiency.

2. Discussion of the Related Art

In recent years, a light emitting diode (LED) has attracted considerable attention due to various advantages thereof, such as high efficiency, diversity of colors, and high freedom in design.

The light emitting diode is a semiconductor device that emits light when forward voltage is applied thereto. The light emitting diode exhibits electrical, optical, and physical properties, such as long lifespan, low power consumption, and mass producibility. For this reason, light emitting diodes are rapidly replacing incandescent lamps and fluorescent lamps.

Meanwhile, a structure to effectively dissipate heat generated from the light emitting diode is required. In order to dissipate heat generated from the light emitting diode outward, a heat sink made of a metal material is used.

In a conventional heat sink, convection of external air is generated only at the outer circumference of the heat sink. As a result, it is difficult to increase convection area for heat exchange. Furthermore, such heat exchange is performed only at places distant from a light emission source, such as the light emitting diode.

Meanwhile, the light emitting diode emits light in a relatively straight direction and has a small emission angle with the result that light distribution characteristics of the light emitting diode are deteriorated. In particular, for a down light type lighting apparatus mounted at a ceiling, it is important to adjust a beam angle and to prevent a glare phenomenon due to straight emission of light from the light emitting diode.

In particular, for an LED lighting apparatus, various structures have been developed to change the direction of light emitted from the LED or to scatter the light emitted from the LED, thereby improving heat dissipation efficiency and, at the same time, easily adjusting a beam angle and preventing a glare phenomenon.

### SUMMARY OF THE INVENTION

Accordingly, the present invention is directed to a lighting apparatus that substantially obviates one or more problems due to limitations and disadvantages of the related art.

An object of the present invention is to provide a lighting apparatus with improved heat dissipation efficiency.

Another object of the present invention is to provide a lighting apparatus wherein a flow route of external air passing through a heat sink and retention time of the external air are increased.

Another object of the present invention is to provide a lighting apparatus wherein a glare phenomenon is prevented and a beam angle is easily adjusted.

A further object of the present invention is to provide a lighting apparatus with improved assemblability.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a lighting apparatus includes a heat sink including a plurality of first heat dissipation fins provided in a circumferential direction thereof and a plurality of second heat dissipation fins provided between adjacent twos of the first heat dissipation fins, a light emitting module disposed in the heat sink, a first reflective member provided at the heat sink such that the first reflective member is disposed in the heat sink, the first reflective member extending in a side direction of the light emitting module, and an electronic module to supply power to the light emitting module, wherein external air flows through spaces defined between the adjacent twos of the first heat dissipation fins, spaces defined between the first heat dissipation fins and the second heat dissipation fins, and spaces defined between adjacent twos of the second heat dissipation fins.

Therefore, it is possible to increase retention time of the external air passing through the heat sink and convection heat exchange area of the external air.

The lighting apparatus may further include first heat dissipation holes provided between the adjacent twos of the first heat dissipation fins and second heat dissipation holes provided between the adjacent twos of the second heat dissipation fins, wherein the first heat dissipation holes may be located to face the second heat dissipation fins and the second heat dissipation holes may be located to face the first heat dissipation fins.

The external air may flow along a flow route changed at least twice during passage through the heat sink.

The first heat dissipation fins and the second heat dissipation fins may be spaced from the first reflective member by predetermined distances and the distance between the first heat dissipation fins and the first reflective member may be smaller than that between the second heat dissipation fins and the first reflective member.

The first reflective member may be provided with a plurality of heat dissipation holes, the respective heat dissipation holes may communicate with spaces defined between adjacent ones of the first heat dissipation fins, and the external air may flow through the heat dissipation holes, spaces defined between the adjacent twos of the first heat dissipation fins, the spaces defined between the first heat dissipation fins and the second heat dissipation fins, and spaces defined between the adjacent twos of the second heat dissipation fins.

The heat sink may have a mounting part at which the light emitting module is mounted and the first heat dissipation fins and the second heat dissipation fins may extend from the mounting part with different radii of curvature.

The first heat dissipation fins may protrude farther toward the first reflective member than the second heat dissipation fins.

Each of the first heat dissipation fins may include a curved part extending from the mounting part at a predetermined radius of curvature and a plane part bent from the curved part.

The first reflective member may include a hemispherical reflective part facing the curved part of each of the first heat dissipation fins and a rim part facing the plane part of each of the first heat dissipation fins and the rim part may be provided with a plurality of heat dissipation holes arranged in a circumferential direction thereof.

The heat dissipation holes may be provided at positions corresponding to spaces defined between adjacent ones of the plane parts and the external air may flow through the heat dissipation holes, the spaces defined between the adjacent twos of the first heat dissipation fins, the spaces defined between the first heat dissipation fins and the second heat dissipation fins, and the spaces defined between the adjacent twos of the second heat dissipation fins.

The lighting apparatus may further include a first fastening member fixed to the rim part through the plane part.

The lighting apparatus may further include a second fastening member fixed to the electronic module through the heat sink.

In the meantime, the heat sink may include a first heat sink and a second heat sink. Also, the first heat sink and the second heat sink may overlap each other.

The heat sink may include a first heat sink having a plurality of first heat dissipation holes and a plurality of first heat dissipation fins and a second heat sink having a plurality of second heat dissipation holes and a plurality of second heat dissipation fins, the second heat sink being mounted at the first heat sink such that at least a portion of the second heat sink is spaced from the first heat sink by a predetermined distance.

The first heat sink and the second heat sink may be formed in a hemispherical shape, a sectional area of which increases with increasing distance from the light emitting module, and the second heat sink may be disposed in the first heat sink.

The second heat sink may be provided with a first catching protrusion and the first heat sink may be provided with a second catching protrusion coupled to the first catching protrusion according to rotation of the second heat sink.

The lighting apparatus may further include a guide fin extending from each of the first heat dissipation fins toward the second heat sink, wherein the guide fin may be disposed at a predetermined angle to each of the first heat dissipation fins.

The guide fin may be formed such that a length of the guide fin protruding toward the second heat sink increases with increasing distance from the light emitting module.

In order to prevent a glare phenomenon during operation of the lighting apparatus, it is necessary to adjust the direction of light emitted from the light emitting module.

The lighting apparatus may further include a second reflective member to reflect light emitted from the light emitting module to the first reflective member.

The second reflective member may have a greater diameter than the light emitting module.

The lighting apparatus may further include a connection member to space the second reflective member from the light emitting module by a predetermined distance, wherein the connection member may be formed of a light transmitting material.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a lighting apparatus according to a first embodiment of the present invention;

FIG. 2 is an exploded perspective view of components of the lighting apparatus shown in FIG. 1;

FIG. 3 is an exploded side view of the components of the lighting apparatus shown in FIG. 1;

FIG. 4 is a sectional view of the lighting apparatus according to the first embodiment of the present invention;

FIGS. 5A to 5C are a view illustrating a flow route of external air passing through a heat sink constituting the lighting apparatus according to the first embodiment of the present invention;

FIG. 6 is a perspective view showing principal parts of a first reflective member and the heat sink constituting the lighting apparatus according to the first embodiment of the present invention;

FIG. 7 is a rear view of the first reflective member constituting the lighting apparatus according to the first embodiment of the present invention;

FIG. 8 is a front view of the heat sink constituting the lighting apparatus according to the first embodiment of the present invention;

FIGS. 9A to 9C are a conceptual view showing a second reflective member constituting the lighting apparatus according to the first embodiment of the present invention;

FIG. 10 is a perspective view of a lighting apparatus according to a second embodiment of the present invention;

FIG. 11 is an exploded perspective view of components of the lighting apparatus shown in FIG. 10;

FIG. 12 is an exploded view of the components of the lighting apparatus shown in FIG. 10;

FIG. 13 is an exploded perspective view showing a heat sink constituting the lighting apparatus according to the second embodiment of the present invention;

FIG. 14 is an assembled perspective view of the components of the lighting apparatus shown in FIG. 13;

FIG. 15 is an assembled front view of the components of the lighting apparatus shown in FIG. 10; and

FIG. 16 is a perspective view showing a heat sink constituting a lighting apparatus according to a third embodiment of the present invention.

### DETAILED DESCRIPTION OF THE INVENTION

Hereinafter, a lighting apparatus according to an embodiment of the present invention will be described in detail with reference to the accompanying drawings. The accompanying drawings show illustrative forms of the present invention. The accompanying drawings are provided for illustrative purposes only and the technical scope of the invention is not limited thereto.

In addition, the same or corresponding components are denoted by the same reference numerals throughout the drawings and a repetitive description thereof will be omitted. Sizes and shapes of the components shown in the accompanying drawings may be exaggerated or reduced for the convenience of description.

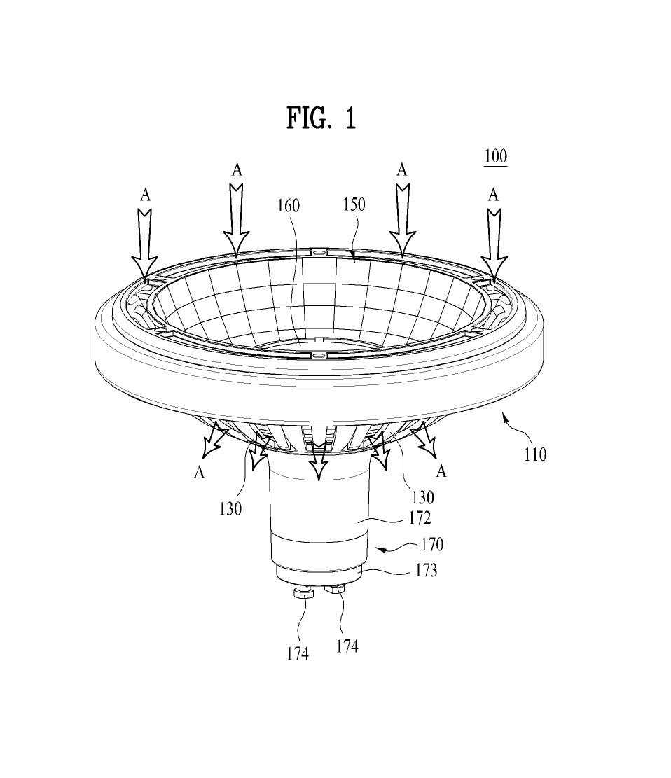

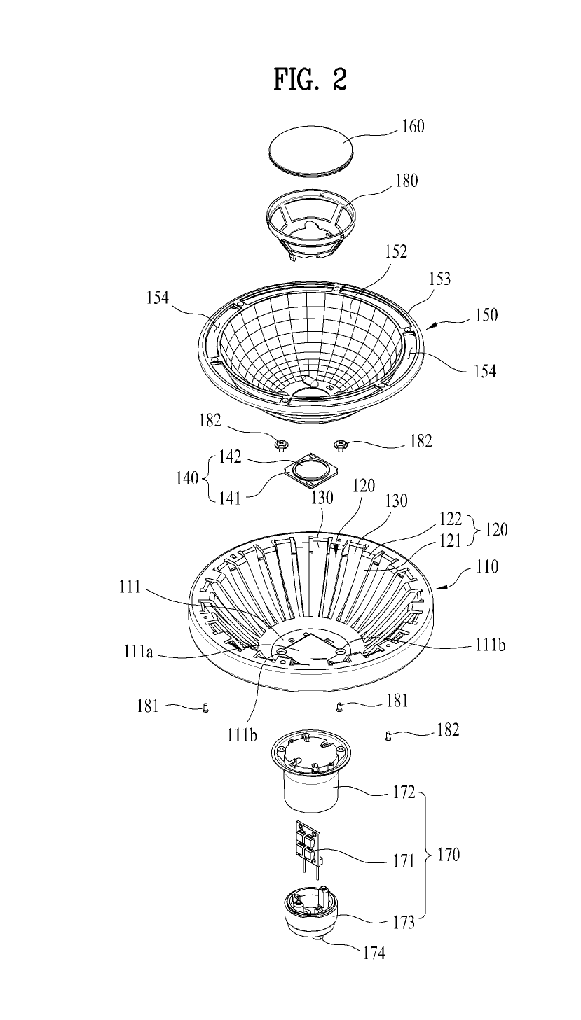

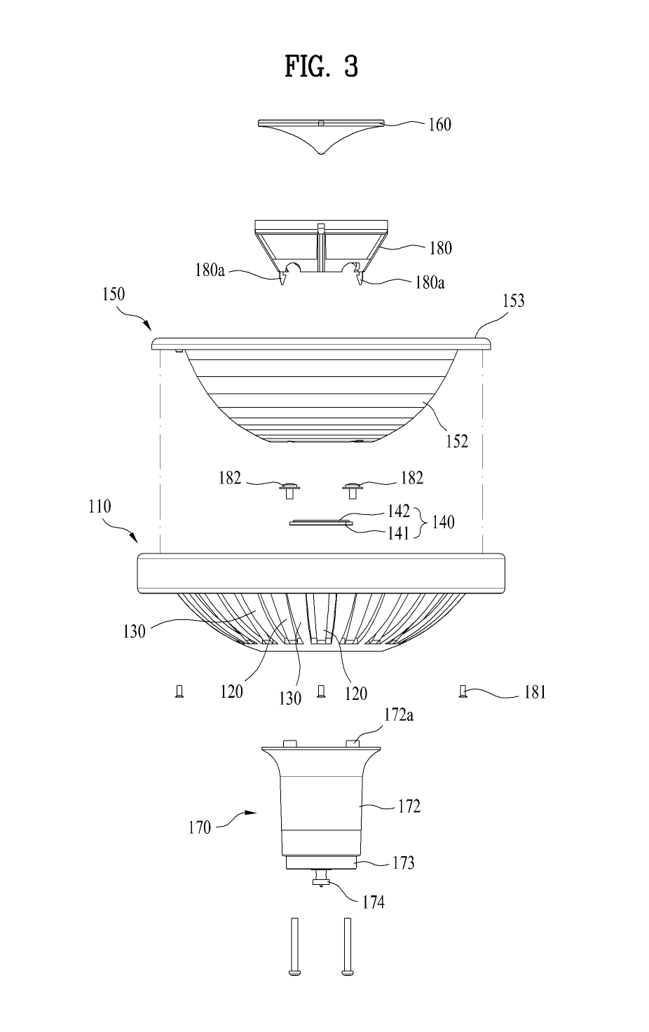

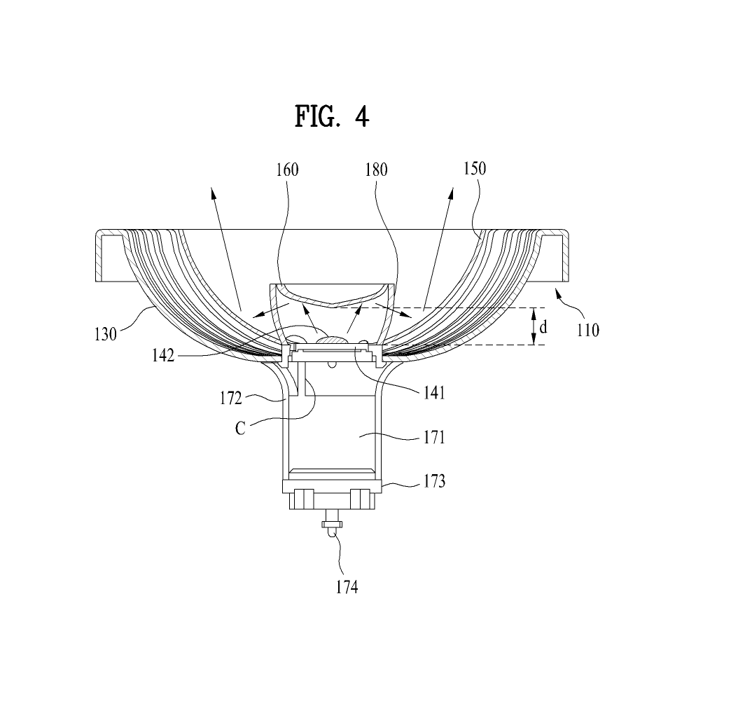

FIG. 1 is a perspective view of a lighting apparatus 100 according to a first embodiment of the present invention, FIG. 2 is an exploded perspective view of components of the lighting apparatus shown in FIG. 1, FIG. 3 is an exploded side view of the components of the lighting apparatus shown in FIG. 1, and FIG. 4 is a sectional view of the lighting apparatus 100 according to the first embodiment of the present invention.

The lighting apparatus 100 according to the first embodiment of the present invention includes a heat sink 110, a light emitting module 140 disposed in the heat sink 110, and an electronic module 170 to supply power to the light emitting module 140.

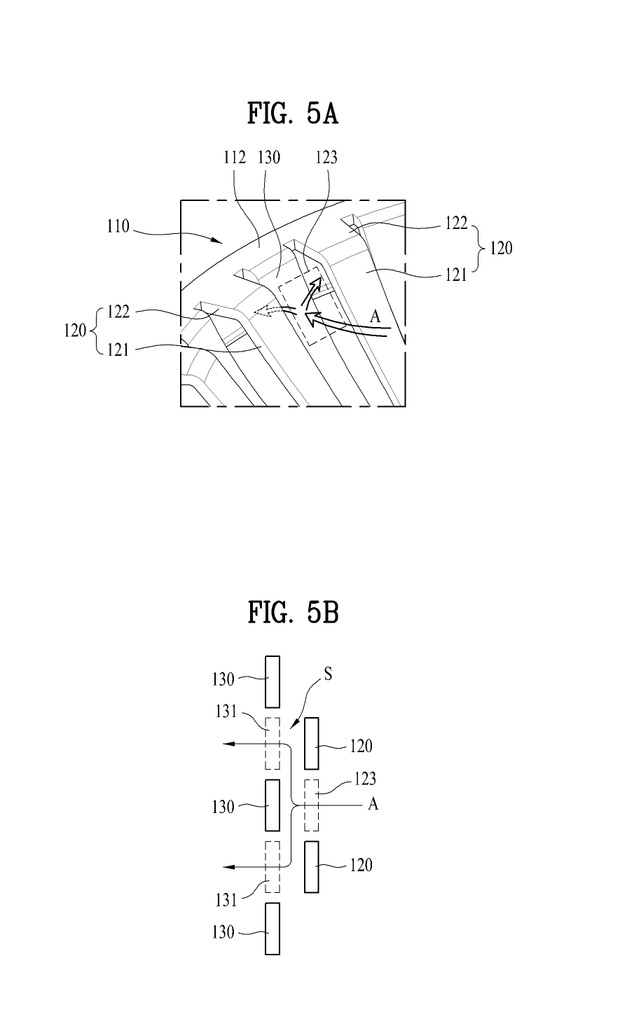

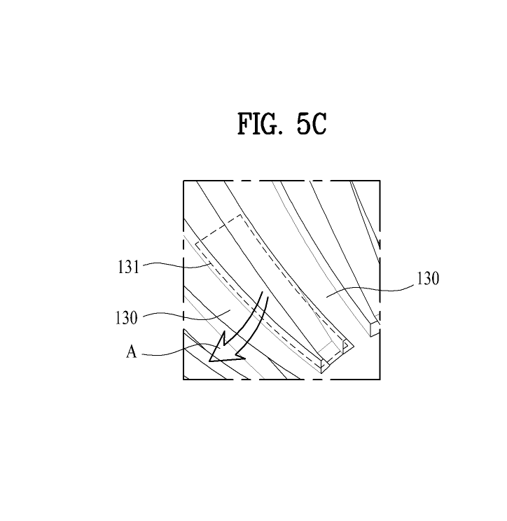

Referring to FIG. 1, the heat sink 110 is provided with a plurality of heat dissipation holes 131 (see FIG. 5) and a plurality of heat dissipation fins 130. External air may flow into and out of the heat sink 110 through the heat dissipation holes 131.

That is, the heat sink 110 is provided with a flow route A defined by the heat dissipation holes 131 and the heat dissipation fins 130. The flow route A may be formed through the heat sink 110.

When power is supplied to the light emitting module 140, the light emitting module 140 emits light and, at the same time, generates heat.

In the lighting apparatus 100, therefore, temperature of a portion of the heat sink 110 increases. As a result, temperature differences among regions of the heat sink 110 are generated. Consequently, natural convection of the external air is generated along the flow route A.

In one embodiment, in a case in which the lighting apparatus 100 is mounted at a ceiling of a space that requires lighting as a down light type lighting fixture, natural convection of external air is achieved as shown in FIG. 1.

The electronic module 170 may include an electronic part 171 to supply power to the light emitting module 140, a case 172 mounted at the heat sink 110 to surround the electronic part 171, and a power socket 173 mounted in the case 172.

The power socket 173 may be provided with a plurality of protruding terminals 174 electrically connected to an external power supply (not shown).

The electronic part 171 may be electrically connected to the light emitting module 140. In one embodiment, the electronic part 171 may be connected to the light emitting module 140 via a cable C. The cable C may be a flexible printed circuit board (FPCB).

The light emitting module 140 may include a circuit board 141 mounted at the heat sink 110 and at least one light emitting diode (LED) 142 mounted on the circuit board 141. A plurality of LEDs 142 may be provided on the circuit board 141.

The light emitting module 140 may be mounted at the heat sink 110. Alternatively, the light emitting module 140 may be mounted at a first reflective member 150.

FIGS. 5A to 5C are a view illustrating the flow route of external air passing through the heat sink constituting the lighting apparatus according to the first embodiment of the present invention. Hereinafter, the structure of the heat sink 110 and the flow route A of external air will be described in detail with reference to FIGS. 5A to 5C.

Referring to FIGS. 2 and 5A to 5C, the lighting apparatus 100 according to the first embodiment of the present invention includes a heat sink 110. The heat sink 110 includes a plurality of first heat dissipation fins 120 provided in a circumferential direction thereof. Also, the heat sink 110 includes a plurality of second heat dissipation fins 130 provided between adjacent twos of the first heat dissipation fins 120.

In addition, the lighting apparatus 100 includes a light emitting module 140 mounted at the heat sink 110 and an electronic module 170 to supply power to the light emitting module 140. Also, the lighting apparatus 100 includes a first reflective member 150 mounted at the heat sink 110 such that the first reflective member 150 is disposed in the heat sink 110, the first reflective member 150 extending in a side direction of the light emitting module 140.

When natural convection of external air is generated, the external air flows through spaces 123 defined between the adjacent twos of the first heat dissipation fins 120, spaces S defined between the first heat dissipation fins 120 and the second heat dissipation fins 130, and spaces 131 defined between adjacent twos of the second heat dissipation fins 130.

The structure of the heat sink 110 is configured as described above in order to increase retention time of external air, the flow route A of the external air, and convection heat exchange area of the external air.

Specifically, first heat dissipation holes 123 may be provided between the adjacent twos of the first heat dissipation fins 120 and second heat dissipation holes 131 may be provided between the adjacent twos of the second heat dissipation fins 130.

That is, the first heat dissipation fins 120 may be provided in a circumferential direction of the heat sink 110 such that the first heat dissipation fins 120 are spaced from each other by a predetermined distance and the second heat dissipation fins 130 may be provided in the circumferential direction of the heat sink 110 such that the second heat dissipation fins 130 are spaced from each other by a predetermined distance.

The first heat dissipation holes 123 may be located to face the second heat dissipation fins 130 and the second heat dissipation holes 131 may be located to face the first heat dissipation fins 120.

Referring to FIGS. 5A to 5C, external air, introduced into the first heat dissipation holes 123, may collide with the second heat dissipation fins 130. As a result, the flow route A may be changed once. The external air may flow through the spaces S defined between the first heat dissipation fins 120 and the second heat dissipation fins 130 and may be discharged outward from the lighting apparatus 100 through the second heat dissipation holes 131.

The external air may be divided into two portions in each of the spaces S defined between the first heat dissipation fins 120 and the second heat dissipation fins 130.

Consequently, the flow route A of the external air may be changed while the external air passes through the heat sink 110. In particular, the flow route A of the external air may be changed at least twice while the external air passes through the heat sink 110. In a case in which the flow route A of the external air is complex as described above, it is possible to increase retention time of the external air passing through the heat sink 110 and convection heat exchange area of the external air.

The heat sink 110 may be formed in a hemispherical shape. The heat sink 110 may be provided with a mounting part 111 at which the light emitting module 140 is mounted.

The first heat dissipation fins 120 and the second heat dissipation fins 130 may extend from the mounting part 111.

In particular, the first heat dissipation fins 120 and the second heat dissipation fins 130 may extend from the mounting part 111 at a predetermined radius of curvature. Alternatively, the first heat dissipation fins 120 and the second heat dissipation fins 130 may extend from the mounting part 111 with different radii of curvature.

In addition, the heat sink 110 is provided with a ring part 112 connected to the first heat dissipation fins 120 extending from the mounting part 111 and to the second heat dissipation fins 130 extending from the mounting part 111.

Consequently, the heat sink 110 may be formed in a hemispherical shape, the sectional area of which increases with increasing distance from the mounting part 111 due to the first heat dissipation fins 120 and the second heat dissipation fins 130. For example, the mounting part 111 may have a minimum diameter and the ring part 112 may have a maximum diameter.

The first heat dissipation fins 120 and the second heat dissipation fins 130 may be formed of a metal or resin material exhibiting high thermal conductivity. In one embodiment, the first heat dissipation fins 120 and the second heat dissipation fins 130 may be formed by punching and bending an aluminum sheet.

On the other hand, the first heat dissipation fins 120 and the second heat dissipation fins 130 may be formed in a shape having a width increasing with increasing distance from the light emitting module 140.

In this case, the first heat dissipation fins 120 and the second heat dissipation fins 130 may have the same width.

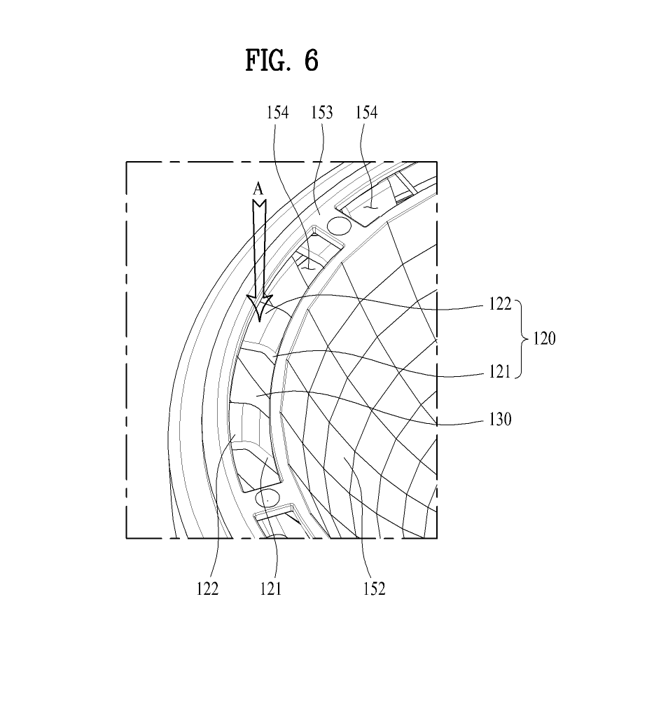

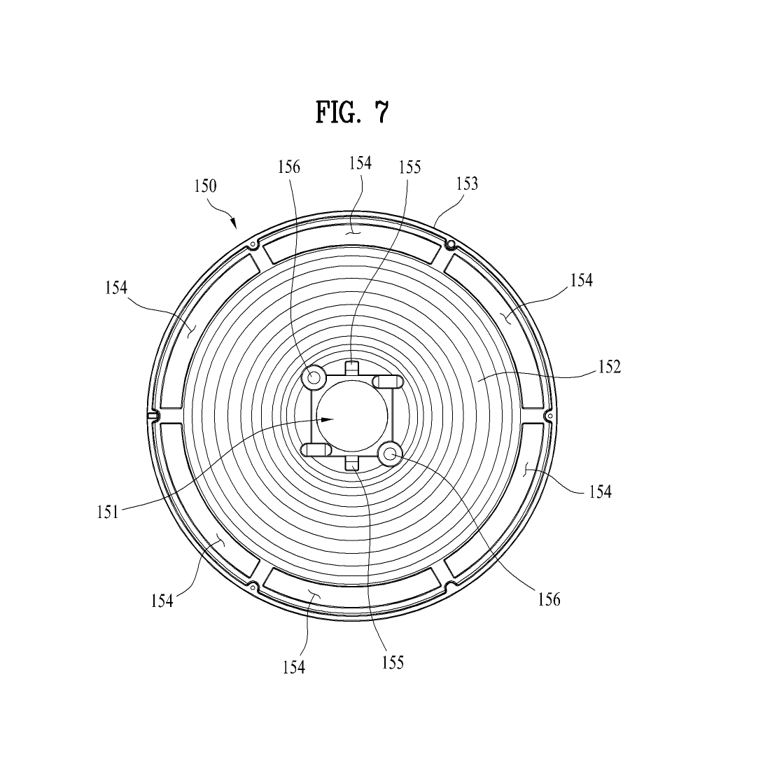

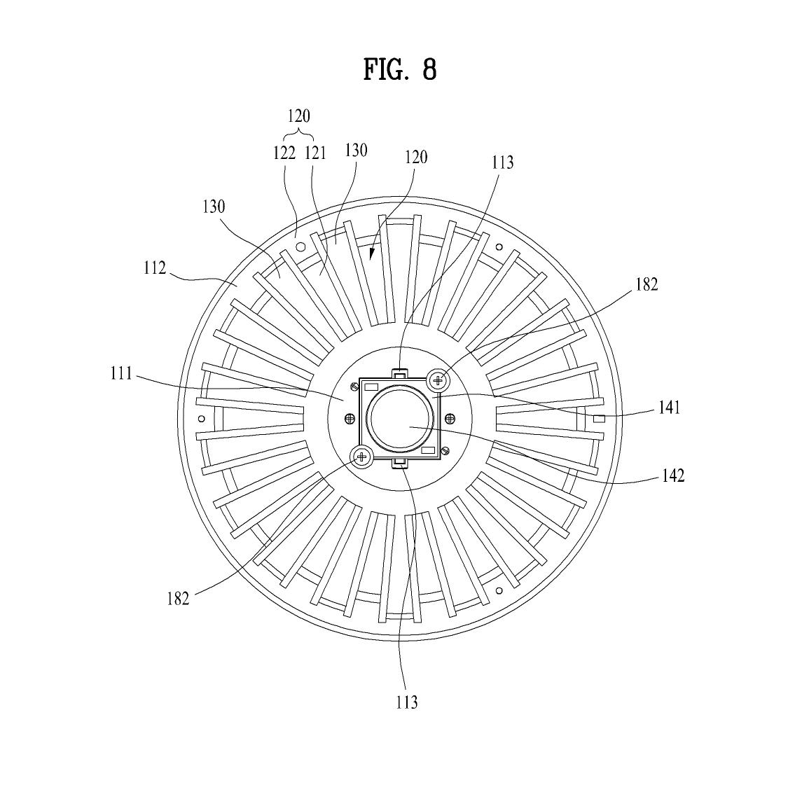

FIG. 6 is a perspective view showing principal parts of the first reflective member 150 and the heat sink 110 constituting the lighting apparatus 100 according to the first embodiment of the present invention, FIG. 7 is a rear view of the first reflective member constituting the lighting apparatus according to the first embodiment of the present invention, and FIG. 8 is a front view of the heat sink constituting the lighting apparatus according to the first embodiment of the present invention.

As previously described, the first reflective member 150 may extend in the side direction of the light emitting module 140. The first reflective member 150 reflects light emitted from the light emitting module 140 outward.

In addition, the first reflective member 150 may be formed in a hemispherical shape, the sectional area of which increases with increasing distance from the light emitting module 140.

In this case, the first heat dissipation fins 120 and the second heat dissipation fins 130 are spaced from the first reflective member 150 by predetermined distances.

In addition, the distance between the first heat dissipation fins 120 and the first reflective member 150 may be smaller than that between the second heat dissipation fins 130 and the first reflective member 150.

That is, the first heat dissipation fins 120 may protrude farther toward the first reflective member 150 than the second heat dissipation fins 130.

In this structure, the external air may flow through spaces defined between the first reflective member 150 and the first heat dissipation fins 120, the spaces 123 defined between the adjacent twos of the first heat dissipation fins 120, the spaces S defined between the first heat dissipation fins 120 and the second heat dissipation fins 130, and the spaces 131 defined between the adjacent twos of the second heat dissipation fins 130.

That is, the flow route A of the external air may be defined by the spaces defined between the first reflective member 150 and the first heat dissipation fins 120, the spaces 123 defined between the adjacent twos of the first heat dissipation fins 120, the spaces S defined between the first heat dissipation fins 120 and the second heat dissipation fins 130, and the spaces 131 defined between the adjacent twos of the second heat dissipation fins 130.

In addition, the first reflective member 150 may be provided with a plurality of heat dissipation holes 154. The respective heat dissipation holes 154 may communicate with spaces defined between adjacent ones of the first heat dissipation fins 120.

In addition, the external air may flow through the heat dissipation holes 154, the spaces defined between the adjacent twos of the first heat dissipation fins 120, the spaces S defined between the first heat dissipation fins 120 and the second heat dissipation fins 130, and the spaces defined between the adjacent twos of the second heat dissipation fins 130.

That is, the flow route A of the external air may be defined by the heat dissipation holes 154 of the first reflective member 150, the spaces defined between the adjacent twos of the first heat dissipation fins 120, the spaces S defined between the first heat dissipation fins 120 and the second heat dissipation fins 130, and the spaces defined between the adjacent twos of the second heat dissipation fins 130.

Meanwhile, each of the first heat dissipation fins 120 may include a curved part 121 extending from the mounting part 111 at a predetermined radius of curvature and a plane part 122 bent from the curved part 121. That is, the plane part 122 may be bent from the curved part 121 such that each of the first heat dissipation fins 120 protrudes toward the first reflective member 150.

In addition, the plane part 122 may be provided on the same plane as the ring part 112 of the heat sink 110.

Meanwhile, the first reflective member 150 may include a hemispherical reflective part 152 facing the curved part 121 of each of the first heat dissipation fins 120 and a rim part 153 facing the plane part 122 of each of the first heat dissipation fins 120.

The rim part 153 may be provided with a plurality of heat dissipation holes 154 arranged in a circumferential direction thereof.

Referring to FIG. 6, the heat dissipation holes 154 may be provided at positions corresponding to spaces defined between adjacent ones of the plane parts 122 and the external air may flow through the heat dissipation holes 154, the spaces defined between the adjacent twos of the first heat dissipation fins, the spaces defined between the first heat dissipation fins and the second heat dissipation fins, and the spaces defined between the adjacent twos of the second heat dissipation fins.

More specifically, the flow route A of the external air may be defined by the heat dissipation holes 154 of the rim part 153, the spaces defined between adjacent ones of the plane parts 122, the spaces S defined between the first heat dissipation fins and the second heat dissipation fins, and the spaces 131 defined between the adjacent twos of the second heat dissipation fins 130.

Meanwhile, the lighting apparatus 100 may further include first fastening members 181 fixed to the first reflective member 150 through the heat sink 110.

Specifically, the first fastening members 181 may be screws. The first fastening members 181 may be fixed to the rim part 153 of the first reflective member 150 through the plane parts 122 of the first heat dissipation fins 120.

Meanwhile, the lighting apparatus 100 may further include second fastening members 182 fixed to the case 172 of the electronic module 170 through the heat sink 110.

Specifically, the second fastening members 182 may be fastening bolts. The second fastening members 182 may be fixed to the case 172 of the electronic module 170 through the mounting part 111 of the heat sink 110.

In addition, the second fastening members 182 may be fixed to the case 172 of the electronic module 170 through the mounting part 111 of the heat sink 110 and the circuit board 141 of the light emitting module 140.

In addition, in order to fix the second fastening members 182, the case 172 may be provided with fastening bosses 172a extending toward the light emitting module 140.

In addition, in order to improve assemblability and to reduce the number of manufacturing processes, the light emitting module 140 and the heat sink 110 may be integrally fastened to the case 172 using the second fastening members 182.

Meanwhile, light emitted outward from the lighting apparatus 100 through the first reflective member 150 may have a predetermined beam angle. The light may be uniformly reflected from the entire area of the first reflective member 150 and then discharged.

In addition, in order to prevent a glare phenomenon during operation of the lighting apparatus 100, it is necessary to adjust the direction of light emitted from the light emitting module 140 before the light is discharged outward through the first reflective member 150 such that the light emitting module 140 in the lighting apparatus 100 is not exposed like a point light source. To this end, the lighting apparatus 100 may further include a second reflective member 160 to reflect light emitted from the light emitting module 140 to the first reflective member 150.

In addition, the lighting apparatus 100 may further include a connection member 180 to space the second reflective member 160 from the light emitting module 140 by a predetermined distance d. The connection member 180 may be formed of a light transmitting material.

The second reflective member 160 functions to reflect light emitted from the light emitting module 140 to the first reflective member 150. To this end, the second reflective member 160 is spaced from the light emitting module 140 by the predetermined distance d.

In addition, the second reflective member 160 may be provided such that the distance between the second reflective member 160 and the light emitting module 140 can be adjusted. In this case, the beam angle of the lighting apparatus 100 may be adjusted according to the distance d between the second reflective member 160 and the light emitting module 140.

In addition, the second reflective member 160 may have a greater diameter than the light emitting module 140. Specifically, the diameter of the second reflective member 160 may be greater than that of the LED 142 of the light emitting module 140.

In this structure, in a case in which the lighting apparatus 100 is observed from outside, the LED 142 may not be exposed outward due to the second reflective member 160, thereby preventing a glare phenomenon.

In addition, the second reflective member 160 may be moved upward and downward in a height direction of the connection member 180 and the beam angle of the lighting apparatus 100 may be adjusted according to the distance d between the second reflective member 160 and the light emitting module 140 as described above.

In addition, the first reflective member 150 functions to reflect at least one selected from between light reflected by the second reflective member 160 and light emitted from the light emitting module 140 outward from the lighting apparatus 100.

In addition, the reflective part 152 of the first reflective member 150 may be provided with an aluminum deposition layer to increase reflectance.

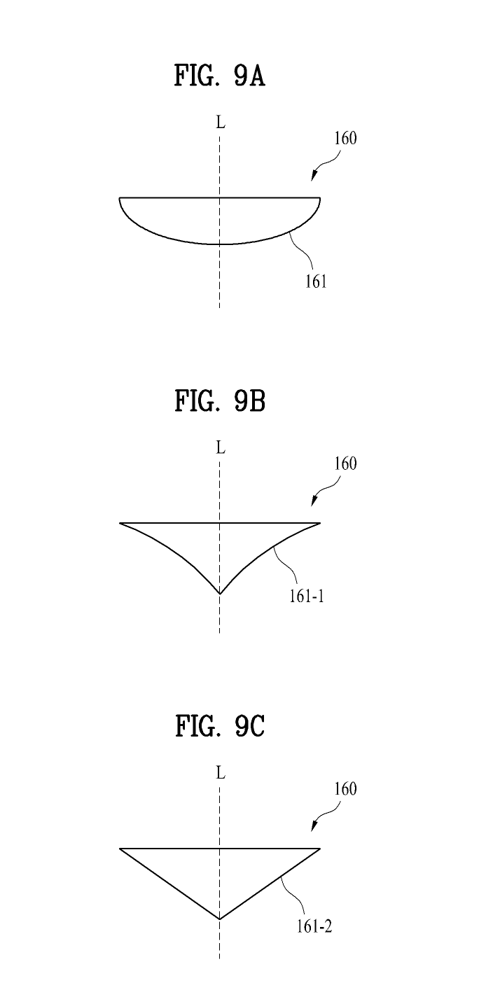

FIGS. 9A to 9C are a conceptual view showing the second reflective member constituting the lighting apparatus according to the first embodiment of the present invention.

Referring to FIGS. 9A to 9C, the second reflective member 160 may be formed in a convex or concave shape. In particular, a reflective surface 161 of the second reflective member 160 may be formed in a shape convex or concave toward the light emitting module 140.

In addition, the second reflective member 160 may be symmetric with respect to an optical axis L of the light emitting module 140.

FIG. 9A shows a case in which the reflective surface 161 is convex toward the light emitting module 140 and FIG. 9B shows a case in which a reflective surface 161-1 is concave toward the light emitting module 140.

In addition, FIG. 9C shows a case in which the diameter of a reflective surface 161-2 linearly decreases toward the light emitting module 140. That is, the reflective surface of the second reflective member 160 may be formed in various shapes.

Hereinafter, the structure in which the first reflective member 150 and the heat sink 110 are mounted will be described in detail.

Referring to FIGS. 2 and 8, the mounting part 111 is provided at the heat sink 110. The mounting part 111 may be provided with a recess 111a, in which a portion of the circuit board 141 of the light emitting module 140 may be disposed in an inserted state. During an assembly process of the lighting apparatus 100, the position of the light emitting module 140 may be easily aligned due to the recess 111a.

In addition, the mounting part 111 may be provided with at least one fastening hole 111b, through which the second fastening members 182 extend. A plurality of fastening holes 111b may be provided at the mounting part 111.

The recess 111a may partially overlap with the respective fastening holes 111b. In this case, the light emitting module 140 and the heat sink 110 may be integrally fastened to the electronic module 170 using the second fastening members 182 as previously described.

Referring to FIG. 7, the first reflective member 150 is provided with a through hole 151, into which the light emitting module 140 is inserted. In addition, the first reflective member 150 is provided with recesses 156, in which portions of the second fastening members 182 are received.

The recesses 156 prevent heads of the respective second fastening members 182 from being exposed outward.

Meanwhile, the first reflective member 150 and the heat sink 110 may be assembled using various methods. In one embodiment, the first reflective member 150 may be provided with a mounting protrusion (not shown) and the heat sink 110 may be provided with a mounting hole (not shown), into which the mounting protrusion is inserted and fixed.

Consequently, the first reflective member 150 may be removably mounted to the heat sink 110. Of course, the first reflective member 150 may be fixed to the heat sink 110 using the second fastening members 182 or other fastening members.

Meanwhile, referring to FIGS. 3 and 8, the first reflective member 150 may be integrally mounted to the heat sink 110 via the connection member 180.

To this end, the connection member 180 may be provided with one or more mounting protrusions 180a, the first reflective member 150 may be provided with first fastening holes 155, through which the mounting protrusions 180a extend, and the mounting part 111 of the heat sink 110 may be provided with second fastening holes 113, in which the mounting protrusions 180a are caught and fixed.

In this structure, the mounting protrusions 180a of the connection member 180 may be caught and fixed to the heat sink 110 through the first fastening holes 155 and the second fastening holes 113.

In addition, the second reflective member 160 may be removably mounted to the connection member 180. In one embodiment, the second reflective member 160 may be provided at the outer circumference thereof with a first spiral part and the connection member 180 may be provided at the inner circumference thereof with a second spiral part coupled to the first spiral part.

Alternatively, the second reflective member 160 may be mounted to the connection member 180 in a hook type coupling fashion.

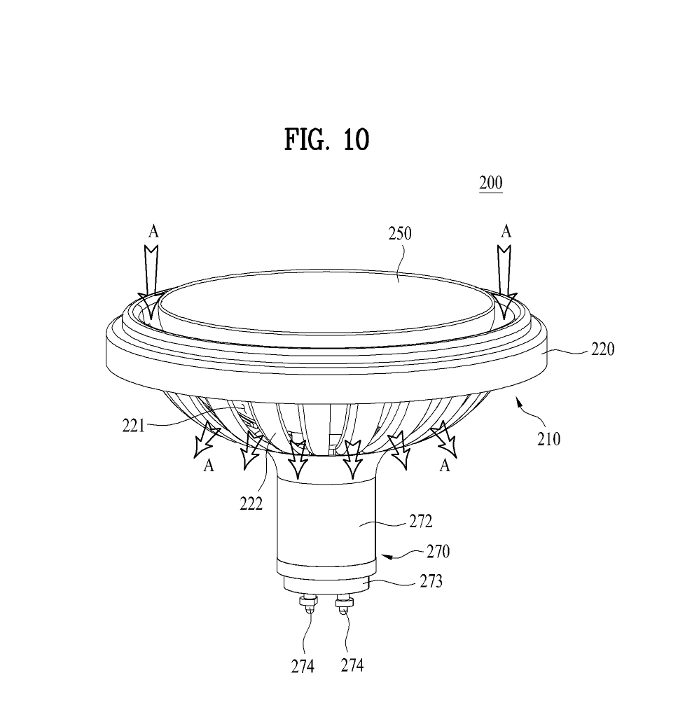

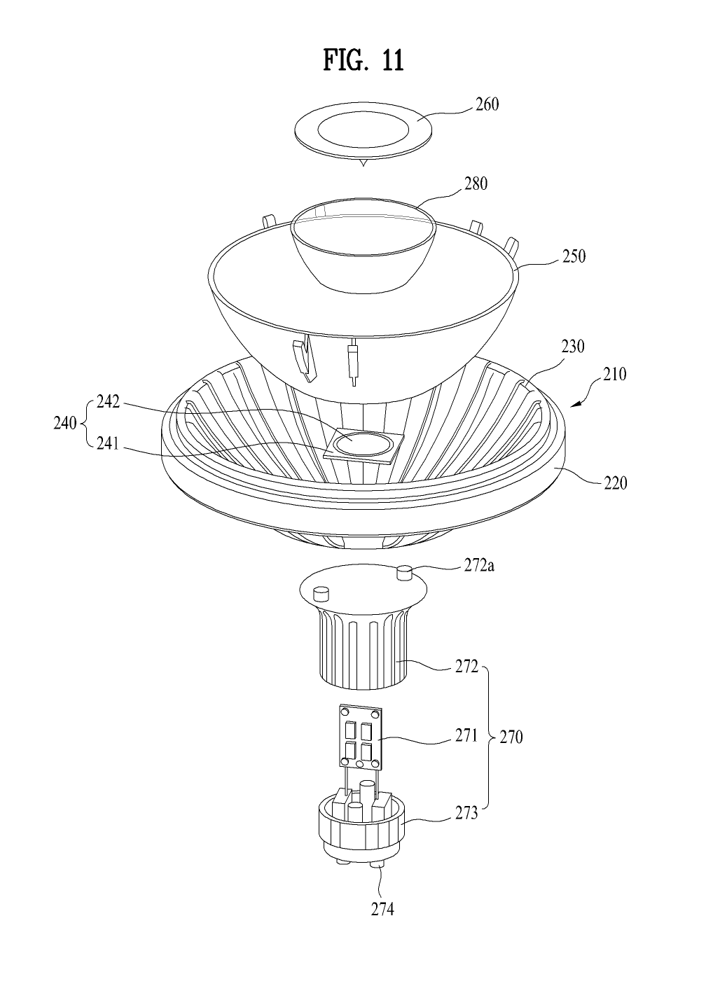

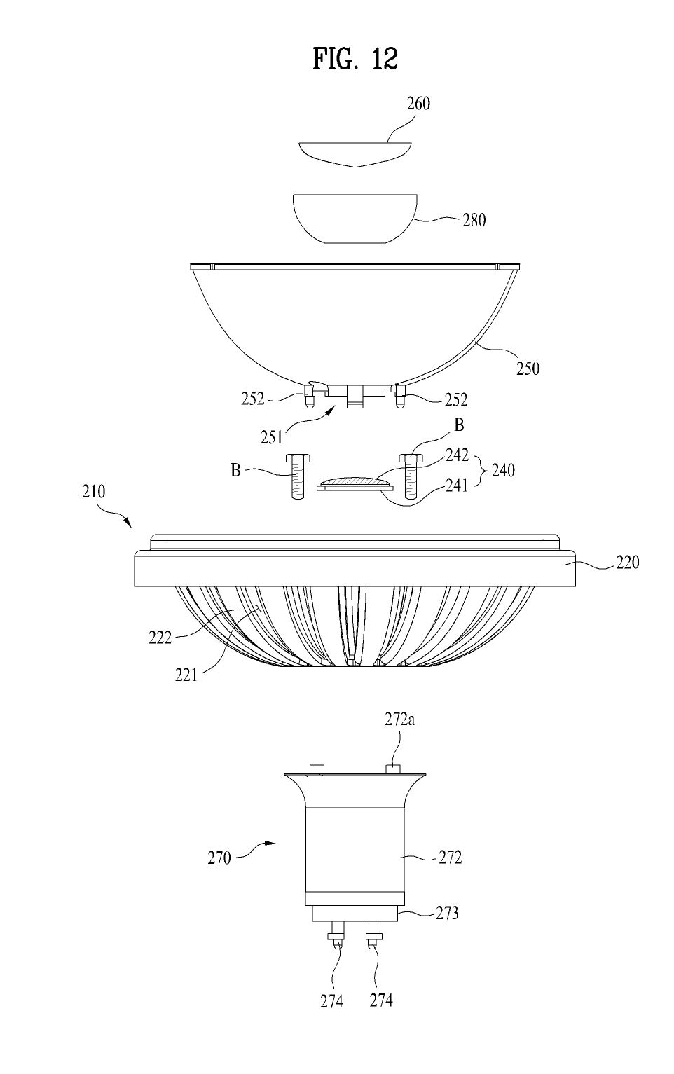

FIG. 10 is a perspective view of a lighting apparatus 200 according to a second embodiment of the present invention, FIG. 11 is an exploded perspective view of components of the lighting apparatus shown in FIG. 10, and FIG. 12 is an exploded view of the components of the lighting apparatus shown in FIG. 10.

The lighting apparatus 200 according to the second embodiment of the present invention includes a heat sink 210, a light emitting module 240 mounted at the heat sink 210, and an electronic module 270 to supply power to the light emitting module 240.

The heat sink 210 is provided with a plurality of heat dissipation holes and a plurality of heat dissipation fins. External air A may flow into and out of the heat sink 210 through the heat dissipation holes.

The electronic module 270 may include an electronic part 271 to supply power to the light emitting module 240, a case 272 mounted at the heat sink 210 to surround the electronic part 271, and a power socket 273 mounted in the case 272.

The power socket 273 may be electrically connected to an external power supply (not shown). In addition, the power socket 273 may be provided with a plurality of terminals 274 protruding outward so as to be connected to an external device.

The electronic part 271 may be electrically connected to the light emitting module 240. In one embodiment, the electronic part 271 may be connected to the light emitting module 240 via a cable C. The cable C may be a flexible printed circuit board.

The light emitting module 240 may include a circuit board 241 mounted at the heat sink 210 and at least one LED 242 mounted on the circuit board 241. A plurality of LEDs 242 may be provided on the circuit board 241.

Meanwhile, in order to define a flow route to increase retention time of external air A and convection heat exchange area of the external air, the heat sink 210 may include a first heat sink 220 and a second heat sink 230. In one embodiment, the first heat sink 220 and the second heat sink 230 may overlap each other.

Hereinafter, the heat sink 210 will be described in detail with reference to the accompanying drawings.

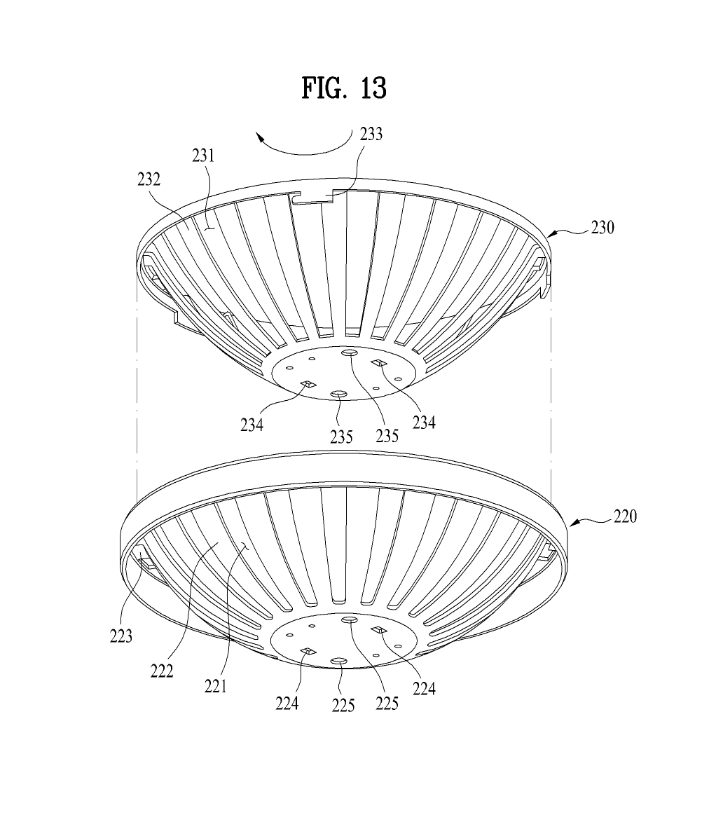

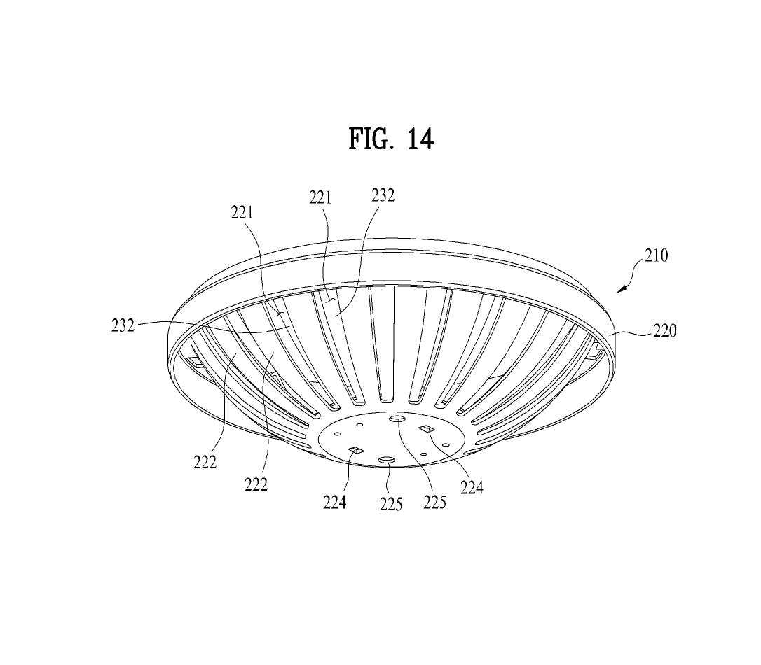

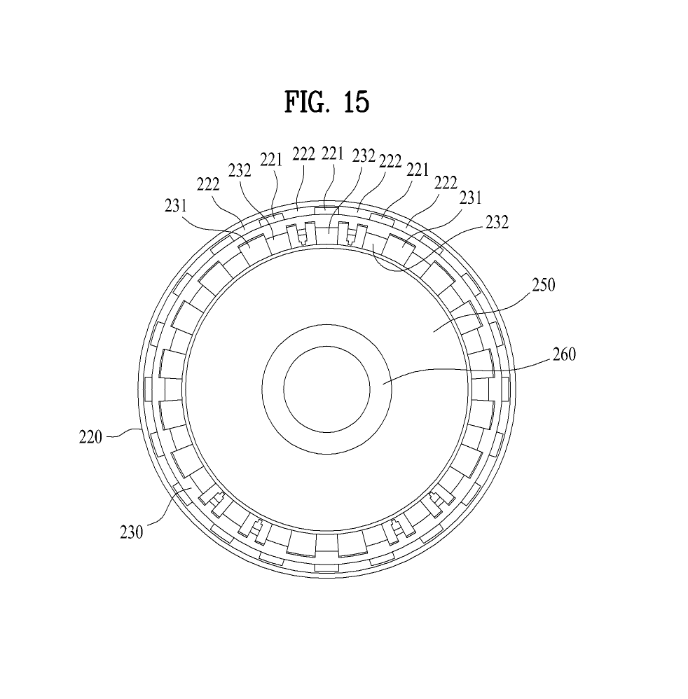

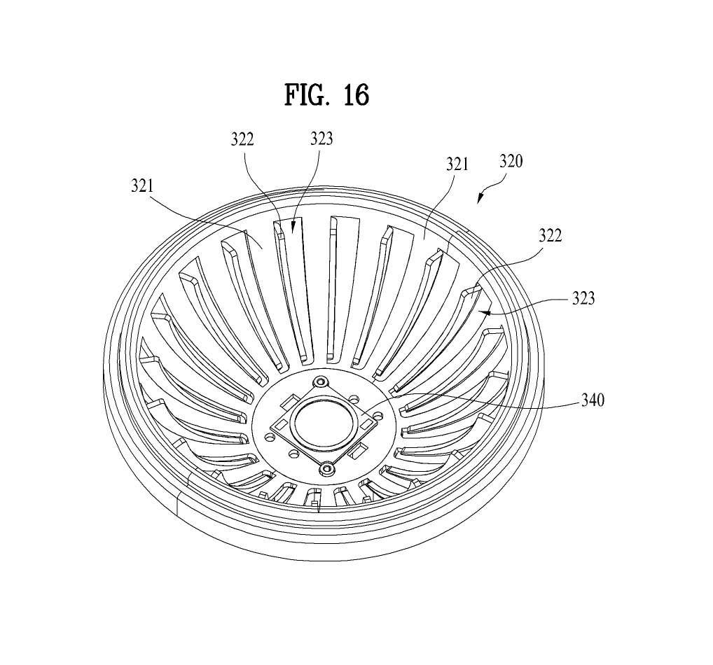

FIG. 13 is an exploded perspective view showing the heat sink 210 constituting the lighting apparatus according to the second embodiment of the present invention, FIG. 14 is an assembled perspective view of the components of the lighting apparatus shown in FIG. 13, and FIG. 15 is an assembled front view of the components of the lighting apparatus shown in FIG. 10.

Specifically, the lighting apparatus 200 includes a first heat sink 220 having a plurality of first heat dissipation holes 221 and a second heat sink 230 having a plurality of second heat dissipation holes 231. The second heat sink 230 is mounted at the first heat sink 220 such that at least a portion of the second heat sink 230 is spaced from the first heat sink 220 by a predetermined distance.

The light emitting module 240 may be mounted at the second heat sink 230.

In addition, the lighting apparatus 200 further includes a first reflective member 250 mounted at the second heat sink 230. The first reflective member 250 extends in a side direction of the light emitting module 240. At least a portion of the first reflective member 250 is spaced from the second heat sink 230 by a predetermined distance.

The electronic module 170 of the lighting apparatus 200 includes an electronic part 271 to supply power to the light emitting module 240 and a case 272 mounted at the first heat sink 220 to surround the electronic part 271.

A portion of the second heat sink 230 is spaced from the first heat sink 220 by a predetermined distance and a portion of the first reflective member 250 is spaced from the second heat sink 230 by a predetermined distance.

Consequently, external air A may flow in a space defined between the first heat sink 220 and the second heat sink 230 and a space defined between the second heat sink 230 and the first reflective member 250 through the first heat dissipation holes 221 and the second heat dissipation holes 231.

The first heat sink 220 and the second heat sink 230 may be formed of a metal or resin material exhibiting high thermal conductivity.

In one embodiment, the first heat sink 220 and the second heat sink 230 may be formed of an aluminum sheet and the first heat dissipation holes 221 and the second heat dissipation holes 231 may be formed by punching the aluminum sheet using a press.

In addition, the first heat sink 220 and the second heat sink 230 may be formed in a hemispherical shape, the sectional area of which increases with increasing distance from the light emitting module. The second heat sink 230 may be disposed in the first heat sink 220.

In this case, the first heat dissipation holes 221 are arranged in a circumferential direction of the hemispheric first heat sink 220 and the second heat dissipation holes 231 are arranged in a circumferential direction of the hemispheric second heat sink 230.

In addition, first heat dissipation fins 222 may be provided between adjacent twos of the first heat dissipation holes 221 of the first heat sink 220 and second heat dissipation fins 232 may be provided between adjacent twos of the second heat dissipation holes 231 of the second heat sink 230.

Meanwhile, in order to manufacture the first heat sink 220 with an aluminum sheet, first, the aluminum sheet may be punched using a press to form the first heat dissipation holes 221. The remaining portion of the aluminum sheet may form the first heat dissipation fins 222.

Subsequently, the aluminum sheet punched using the press may be bent into a hemispherical form to manufacture the first heat sink 220. The second heat sink 230 may also be manufactured using the same method.

Meanwhile, the first heat dissipation holes 221 and the second heat dissipation holes 231 may be formed in a rectangular shape extending with increasing distance from the light emitting module 240. Alternatively, the first heat dissipation holes 221 and the second heat dissipation holes 231 may be formed in a shape having a width increasing with increasing distance from the light emitting module 240.

The first reflective member 250 may extend in the side direction of the light emitting module 240. The first reflective member 250 functions to reflect light emitted from the light emitting module 240 such that the light is discharged outward.

In one embodiment, the first reflective member 250 may be formed in a hemispherical shape, the sectional area of which increases with increasing distance from the light emitting module 240.

In addition, the first reflective member 250 may be removably mounted to the second heat sink 230. The first reflective member 250 may be formed in a hemispherical shape in which a portion of the first reflective member 250 is spaced from the inner circumference of the second heat sink 230 by a predetermined distance.

In addition, the first reflective member 250 may be provided with a through hole 251, into which the light emitting module 240 is inserted, and insertion protrusions 252, by which the first reflective member 250 is mounted at the second heat sink 230.

Meanwhile, the first heat sink 220 may be provided with first insertion holes 224, into which the insertion protrusions 252 of the first reflective member 250 are inserted, and first fastening holes 225, by which the light emitting module 240 is fastened to the first heat sink 220.

In addition, the second heat sink 230 may be provided with second insertion holes 235, into which the insertion protrusions 252 of the first reflective member 250 are inserted, and second fastening holes 235, by which the light emitting module 240 is fastened to the second heat sink 230.

Meanwhile, the lighting apparatus 200 may further include fastening members B fixed to the case 272 of the electronic module 270 through the first heat sink 220 and the second heat sink 230.

Specifically, the fastening members B may be fastening bolts. The fastening members B may be fixed to the case 272 of the electronic module 270 through the second fastening holes 235 of the second heat sink 230 and the first fastening holes 225 of the first heat sink 220.

In addition, in order to fix the fastening members B, the case 272 may be provided with fastening bosses 272a extending toward the light emitting module 240.

In addition, the light emitting module 240, the second heat sink 230, and the first heat sink 220 may be integrally fastened to the case 272 using the fastening members B.

Meanwhile, the structure in which the first heat sink 220 and the second heat sink 230 are assembled may be configured as follows. The second heat sink 230 may be provided with a first catching protrusion 233 and the first heat sink 220 may be provided with a second catching protrusion 223 coupled to the first catching protrusion 233 according to rotation of the second heat sink 230.

A plurality of first catching protrusions 233 may be provided at the second heat sink 230 and a plurality of second catching protrusions 223 may be provided at the first heat sink 220.

The flow route of the external air A defined by the first heat sink 220 and the second heat sink 230 in a state in which the first heat sink 220 and the second heat sink 230 overlap each other may be configured such that the flow direction of the external air A is changed at least twice while the external air A flows into and out of the first heat sink 220 and the second heat sink 230. As needed, the flow direction of the external air A may be changed four times or more.

In a case in which the flow route of the external air A is complex as described above, it is possible to increase retention time of the external air A passing through the heat sink 210 and convection heat exchange area of the external air A.

To this end, the second heat sink 230 may be mounted at the first heat sink 220 such that the first heat dissipation holes 221 and the second heat dissipation holes 231 are not aligned with each other.

That is, in order to increase the convection heat exchange area of the external air A, the external air A introduced through the second heat dissipation holes 231 of the second heat sink 230 does not directly flow to the first heat dissipation holes 221 of the first heat sink 220 but passes by the first heat dissipation fins 222 and is then discharged outward through the first heat dissipation holes 221.

Specifically, the first heat dissipation holes 221 and the second heat dissipation fins 232 may at least partially overlap each other. In addition, the second heat dissipation holes 231 and the first heat dissipation fins 222 may at least partially overlap each other.

In this structure, the external air A, introduced into the second heat dissipation holes 231, may collide with the first heat dissipation fins 222 and then be discharged outward through the first heat dissipation holes 221.

In addition, the second heat sink 230 may be mounted at the first heat sink 220 such that the first heat dissipation holes 221 and the second heat dissipation fins 232 completely overlap each other and the second heat dissipation holes 231 and the first heat dissipation fins 222 completely overlap each other.

Meanwhile, the distance between the first heat sink 220 and the second heat sink 230 may increase with increasing distance from the light emitting module 240. In addition, the distance between the second heat sink 230 and the first reflective member 250 may increase with increasing distance from the light emitting module 240.

Consequently, the external air A may flow in the space defined between the first heat sink 220 and the second heat sink 230 and the space defined between the second heat sink 230 and the first reflective member 250 through the first heat dissipation holes 221 and the second heat dissipation holes 231.

FIG. 16 is a perspective view showing a heat sink 320 constituting a lighting apparatus according to a third embodiment of the present invention.

The heat sink 320 of this embodiment may have a structure modified from the heat sink 110 of the first embodiment or a structure modified from the first heat sink 220 and the second heat sink 230 of the second embodiment.

The heat sink 320 includes a plurality of heat dissipation fins 321 and a plurality of heat dissipation holes 323 provided between adjacent twos of the heat dissipation fins 321.

In this case, each of the heat dissipation fins 321 is provided with a guide fin 322 to guide passage of external air.

The guide fin 322 may extend from each of the first heat dissipation fins 321. In addition, the guide fin 322 may be disposed at a predetermined angle to each of the heat dissipation fins 321.

For the heat sink 210 (see FIG. 13) previously described in the second embodiment of the present invention, the guide fins 322 may be provided at the first heat sink 220.

Specifically, the guide fins 322 extend from the heat dissipation fins 222 toward the second heat sink 230. In this case, the guide fins 322 may be formed such that the length of each of the guide fins 322 protruding toward the second heat sink increases with increasing distance from a light emitting module 340.

Meanwhile, the heat sink 320 may be formed of an aluminum sheet. In a case in which the heat sink 320 is manufactured of the aluminum sheet, the aluminum sheet may be punched to form the heat dissipation holes 323 and the punched portions of the aluminum sheet may be bent to form the guide fins 322.

As is apparent from the above description, in the lighting apparatus according to the embodiment of the present invention, external air flows along the outer circumference of the heat sink and the internal space of the heat sink, thereby improving heat dissipation efficiency.

In addition, in the lighting apparatus according to the embodiment of the present invention, the flow route of external air passing through the heat sink and retention time of the external air are increased.

In addition, in the lighting apparatus according to the embodiment of the present invention, light emitted from the light emitting module is prevented from being discharged only to a specific region.

In addition, in the lighting apparatus according to the embodiment of the present invention, a glare phenomenon is prevented and a beam angle is easily adjusted.

In addition, in the lighting apparatus according to the embodiment of the present invention, the lighting apparatus is easily assembled and disassembled.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A lighting apparatus comprising:
a heat sink comprising a plurality of first heat dissipation fins provided in a circumferential direction thereof and a plurality of second heat dissipation fins provided between adjacent twos of the first heat dissipation fins;
a light emitting module disposed in the heat sink;
a first reflective member provided at the heat sink such that the first reflective member is disposed in the heat sink, the first reflective member extending in a side direction of the light emitting module; and
an electronic module to supply power to the light emitting module, wherein
external air flows through spaces defined between the adjacent twos of the first heat dissipation fins, spaces defined between the first heat dissipation fins and the second heat dissipation fins, and spaces defined between adjacent twos of the second heat dissipation fins.

2. The lighting apparatus according to claim 1, further comprising:
first heat dissipation holes provided between the adjacent twos of the first heat dissipation fins; and
second heat dissipation holes provided between the adjacent twos of the second heat dissipation fins, wherein
the first heat dissipation holes are located to face the second heat dissipation fins, and
the second heat dissipation holes are located to face the first heat dissipation fins.

3. The lighting apparatus according to claim 1, wherein the external air flows along a flow route changed at least twice during passage through the heat sink.

4. The lighting apparatus according to claim 1, wherein
the first heat dissipation fins and the second heat dissipation fins are spaced from the first reflective member by predetermined distances, and
the distance between the first heat dissipation fins and the first reflective member is smaller than that between the second heat dissipation fins and the first reflective member.

5. The lighting apparatus according to claim 1, wherein
the first reflective member is provided with a plurality of heat dissipation holes,
the respective heat dissipation holes communicate with spaces defined between adjacent ones of the first heat dissipation fins, and
the external air flows through the heat dissipation holes, spaces defined between the adjacent twos of the first heat dissipation fins, the spaces defined between the first heat dissipation fins and the second heat dissipation fins, and spaces defined between the adjacent twos of the second heat dissipation fins.

6. The lighting apparatus according to claim 1, wherein
the heat sink has a mounting part at which the light emitting module is mounted, and
the first heat dissipation fins and the second heat dissipation fins extend from the mounting part with different radii of curvature.

7. The lighting apparatus according to claim 6, wherein the first heat dissipation fins protrude farther toward the first reflective member than the second heat dissipation fins.

8. The lighting apparatus according to claim 6, wherein each of the first heat dissipation fins comprises a curved part extending from the mounting part at a predetermined radius of curvature and a plane part bent from the curved part.

9. The lighting apparatus according to claim 8, wherein
the first reflective member comprises a hemispherical reflective part facing the curved part of each of the first heat dissipation fins and a rim part facing the plane part of each of the first heat dissipation fins, and
the rim part is provided with a plurality of heat dissipation holes arranged in a circumferential direction thereof.

10. The lighting apparatus according to claim 9, wherein
the heat dissipation holes are provided at positions corresponding to spaces defined between adjacent ones of the plane parts, and
the external air flows through the heat dissipation holes, the spaces defined between the adjacent twos of the first heat dissipation fins, the spaces defined between the first heat dissipation fins and the second heat dissipation fins, and the spaces defined between the adjacent twos of the second heat dissipation fins.

11. The lighting apparatus according to claim 9, further comprising a first fastening member fixed to the rim part through the plane part.

12. The lighting apparatus according to claim 1, further comprising a second fastening member fixed to the electronic module through the heat sink.

13. The lighting apparatus according to claim 2, wherein the heat sink comprises:
a first heat sink having a plurality of first heat dissipation holes and a plurality of first heat dissipation fins; and
a second heat sink having a plurality of second heat dissipation holes and a plurality of second heat dissipation fins, the second heat sink being mounted at the first heat sink such that at least a portion of the second heat sink is spaced from the first heat sink by a predetermined distance.

14. The lighting apparatus according to claim 13, wherein
the first heat sink and the second heat sink are formed in a hemispherical shape, a sectional area of which increases with increasing distance from the light emitting module, and
the second heat sink is disposed in the first heat sink.

15. The lighting apparatus according to claim 14, wherein
the second heat sink is provided with a first catching protrusion, and
the first heat sink is provided with a second catching protrusion coupled to the first catching protrusion according to rotation of the second heat sink.

16. The lighting apparatus according to claim 13, further comprising:
a guide fin extending from each of the first heat dissipation fins toward the second heat sink, wherein
the guide fin is disposed at a predetermined angle to each of the first heat dissipation fins.

17. The lighting apparatus according to claim 16, wherein the guide fin is formed such that a length of the guide fin protruding toward the second heat sink increases with increasing distance from the light emitting module.

18. The lighting apparatus according to claim 1, further comprising a second reflective member to reflect light emitted from the light emitting module to the first reflective member.

19. The lighting apparatus according to claim 18, wherein the second reflective member has a greater diameter than the light emitting module.

20. The lighting apparatus according to claim 18, further comprising:
a connection member to space the second reflective member from the light emitting module by a predetermined distance, wherein
the connection member is formed of a light transmitting material.
